(19) United States
(12) Patent Application Publication
(10) Pub. No.: US 2004/0250684 A1
(43) Pub. Date: Dec. 16, 2004

(54) Apparatus for continuous carbon dioxide absorption

(76) Inventors: Susan Pran Krumdieck, Christchurch (NZ); Kenneth Neil Marsh, Christchurch (NZ); Matthew Lloyd Brill, Tauranga (NZ); Michael Asher Brown, Perth Western Australia (AU); James Richard Cleland, Christchurch (NZ); Matthew Donald Green, Pukekohe (NZ); Jamie Stuart Wallace, Invercargill (NZ)

Correspondence Address: McCormick Paulding & Huber, CityPlace II, 85 Asylum Street, Hartford, CT, 06103-4102, US

(21) Appl. No.: 10/491,932

(22) PCT Filed: Oct. 7, 2002
(86) PCT No.: PCT/NZ02/00205

(30) Foreign Application Priority Data
Oct. 8, 2001 (NZ) 514666

(51) Int. Cl. B01D 53/14

(52) U.S. Cl. 96/290

(57) ABSTRACT

Apparatus for removing carbon dioxide from a stream of air or other gas, which includes a vertical gas absorption reactor containing loosely packed mixing units submerged in a carbon dioxide absorbent liquid; gas to be treated is admitted at or near this base of the rector, is broken into small bubbles by the mixing units, and passes through the absorbent liquid to remove a high percentage of carbon dioxide; treated gas leaves from the top of the reactor, a regenerator associated with the reactor continually or intermittently regenerates the absorbent liquid and is arranged to receive absorbent liquid to be treated through an outlet from the reactor which is located higher up the wall of the reactor than the inlet for returning treated liquid to the reactor.

The present invention provides apparatus for removing carbon dioxide from a stream of air or other gas, said apparatus including: a substantially vertical gas absorption reactor which contains a plurality of loosely packed mixing units submerged in a carbon dioxide absorbent liquid; said reactor being provided with a gas inlet at or near the base of the reactor, through which or adjacent the top of the reactor through which the outgoing stream of treated gas leaves the incoming stream of gas is admitted in use, and a gas outlet at the reactor in use; said reactor further being provided with a liquid outlet and a liquid inlet in the wall of the reactor, the liquid outlet being located higher up the wall of the reactor than the liquid inlet; a regenerator which incorporates heating means and which is provided with an inlet and the outlet and a carbon dioxide vent; the regenerator inlet being connected to the liquid outlet from the reactor, and the regenerator outlet being connected to the liquid inlet to the reactor.

The carbon dioxide absorbent liquid may be any of a range of liquids known to absorb carbon dioxide, for example, alkanolamines such as monoethanolamine or N-methydlethanolamine either alone or as mixtures with other substances such as glycol in aqueous solution.

By way of example only, a preferred embodiment of the present invention is described in detail with reference to the accompanying drawings, in which:

### BRIEF DESCRIPTION OF DRAWINGS

FIG. 1 is a diagrammatic longitudinal section through the apparatus of the present invention;

FIG. 2 is a diagrammatic longitudinal section through the regenerator section of the apparatus of FIG. 1;

FIG. 3 is a plan view of a mixing unit;

FIG. 4 is a diagrammatic longitudinal section through a second design of regenerator; and

FIG. 5 is a diagrammatic longitudinal section through a third design of regenerator.

### BEST MODE FOR CARRYING OUT THE INVENTION

Referring to the drawings, the apparatus of the present invention comprises an absorption reactor 2 connected to a regenerator 3 by means of an inlet pipe 4 and an outlet pipe 5.

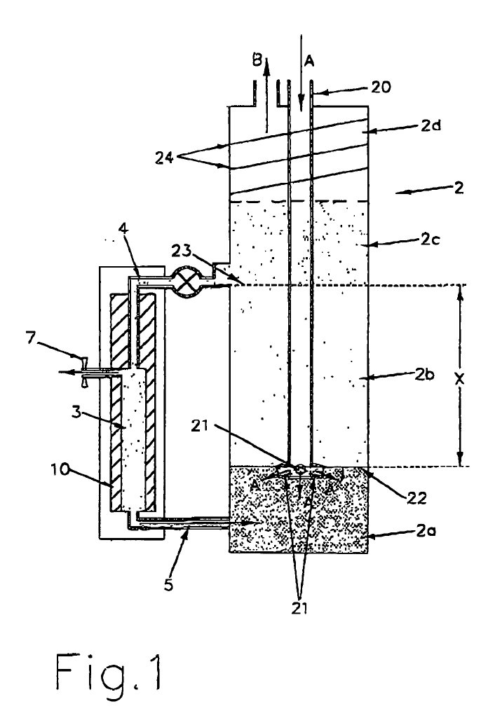

The reactor 2 comprises a cylinder arranged with the longitudinal axis substantially vertical. An air inlet into the reactor 2 is indicated by arrows A; an outlet for the carbon-dioxide scrubbed air is indicated by arrow B. The air inlet clan be mounted in the base of the reactor, but preferably is arranged as shown in FIG. 1: air is introduced into the reactor through a pipe 20 which extends from the top of the reactor to a level space a short distance up from the base of the reactor. Air leaves the pipe 20 through a plurality of equidistantly spaced spigots 21, ensuring a uniform distribution of air.

The lowest portion 2a of the reactor is filled with absorbent liquid. The adjacent portion 2b, which extends for a height X equal to approximately half of the height of the reactor, is filled with loosely packed mixing units submerged in the absorbent liquid. The mixing units are prevented from descending into the portion 2a by a grille 22.

The mixing units may be in the form of any of a range of space-filling units designed to provide a large number of broken, angled, surfaces to that air traveling through the loosely packed mixing units is broken up from a coherent air stream into multiple bubbles. Essentially, the portion 2b of the reactor provides a packed bubble reactor, with the mixing units selected to provide a low solid volume and produce a small bubble size. The use of mixing units is essential for the efficient functioning of the apparatus of the present invention: without the mixing units, the incoming air stream remains in relatively large bubbles and achieves insufficient contact with the absorbent liquid for efficient carbon dioxide removal.

One possible design of mixing unit is shown in FIG. 3: the unit 7 consists of a short open-ended cylinder, the walls of which are pierced by multiple cut-outs 8 which are bent into the interior of the cylinder, forming multiple curved wells within the cylinder.

Breaking up the air stream by passing it through the mixing units produces small air bubbles (typically not larger than 5 mm diameter) and this greatly increases the effective surface area of the air which contacts the absorbent liquid and hence improves the efficiency of absorption of carbon dioxide by the absorbent liquid: the scrubbing efficiency of the reactor is governed by the average bubble size and the residence time of the air bubbles in the portion 2b of the reactor.

Further, breaking up the air stream in this way prevents the incoming air from causing a fountain of liquid to shoot up the top of the reactor 2 and flood out of the gas outlet B.

The portion 2c of the reactor also contains mixing units and forms an operational overflow zone: the level of the absorbent liquid when the reactor is not in use is indicated by broken line 23, but when the reactor is in use, the introduction of the air into the absorbent liquid causes the liquid to froth and lift, in proportion to airflow, with a consequent increase in volume, overflowing into portion 2c.

The uppermost portion 2d of the reactor contains a fine mesh 24 through which air leaving the reactor must pass in order to reach the outlet B. Air passes readily through the mesh, but any droplets of absorbent liquid entrained in the air tend to be rapped by the mesh and drip back into the main body of the absorbent liquid.

The apparatus may include additional or alternative equipment for removing droplets of absorbent liquid: for example, the air may be arranged pass through a cyclone and/or a waterbath. How thoroughly the droplets of absorbent liquid are moved from the outdoing air depends upon the intended end use of the air.

The absorbent liquid may be any of a range of known carbon dioxide absorbent liquids as discussed above. One suitable type of absorbent liquid has been found to be a mixture of monoethanolamine (MEA), monoproplyleneglycol (‘glycol’) and water with the mixture containing 10%-80% MEA, preferably about 30%. Most of the absorption of carbon dioxide is performed by the MEA, with the glycol present primarily as a stabilizer, although the glycol dies absorb some carbon dioxide as well.

The regenerator 3 is in the form of a cylinder arranged with its longitudinal axis parallel to that of the reactor 2. The regenerator inlet pipe 4 is connected between a point on the wall of the reactor 2 slightly above the level of the absorbent liquid when the apparatus is not in use, in the overflow zone 2c, and the top of the regenerator. At the base of the cylinder 3, the regenerator outlet pipe 5 carries regenerated liquid back to the bottom of the reactor 2, opening into the liquid only zone 2a.

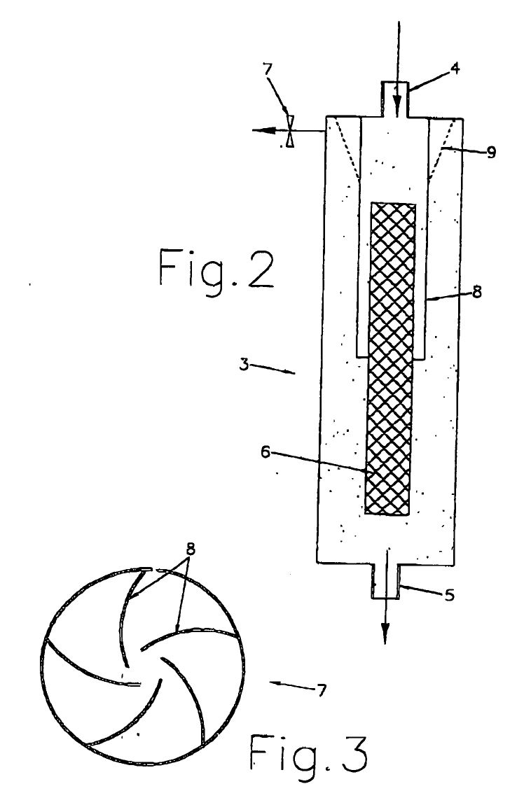

As shown in FIG. 2, inside the regenerator a cylindrical heater 6 is supported co-axially with the cylinder 3, so that liquid entering the regenerator through the inlet 4 trickles down the outside of the heater, heating the liquid.

MEA is regenerated to release the absorbed carbon dioxide simply by heating it to 90° C.-130° C. Thus, as the MEA/glycol solution trickles over the heater 6, the solution boils and the absorbed carbon dioxide gas is released with vapour bubbles, which float up the regenerator cylinder and are exhausted (or collected) through an exhaust valve 7. The carbon dioxide bubbles are prevented from mixing with the incoming stream of liquid entering through the inlet 4 by a cylindrical shield 8 over the upper portion of the heater 6, and by a mesh guide 9 around the top of the shield 8. The carbon dioxide bubbles tend not to pass through the mesh holes, so the mesh guides the bubbles towards the exhaust valve 7.

The regenerator 3 may be surrounded by a heat exchanger 10 (FIG. 1 only) which is used to cool the liquid leaving the regenerator and possibly also to pre-heat liquid entering the regenerator.

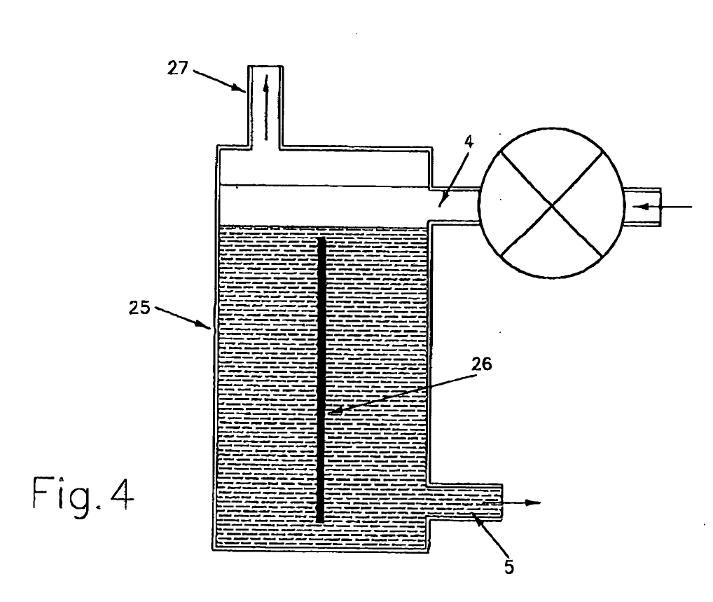

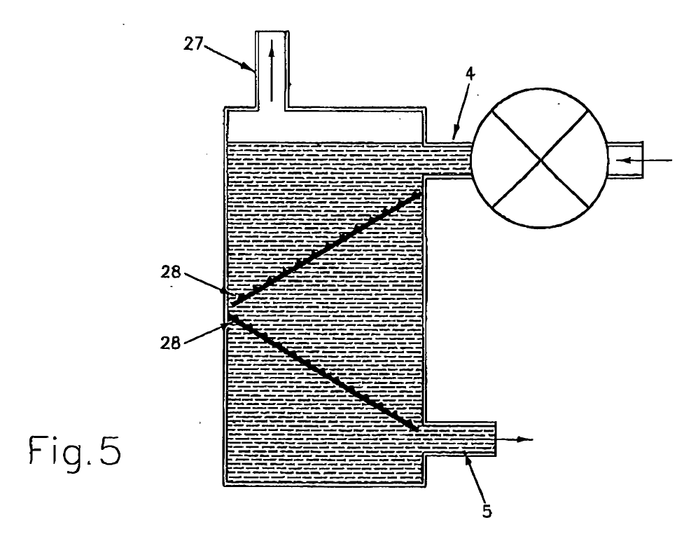

Other designs of regenerator are shown in FIGS. 4 and 5.

In the design shown in FIG. 4, the regenerator 25 is simply a container with the inlet pipe 4 from the reactor connected near the top of the container, the outlet pipe 5 to the reactor connected near the bottom of the container, and a vertical electrically heated heating element 26 mounted centrally in the container. Carbon dioxide released from the absorbent liquid leaves the container through an outlet 27 (Arrow C). This design of regenerator is very cheap to construct and simple to maintain, but the suitable for applications only where a relatively low rate of regeneration is required.

The design shown in FIG. 5 is similar to that of FIG. 4, and the same reference numerals are used where appropriate. However, the FIG. 5 design has a rather more effective heater, in the form of one or more inclined plates 28 (two are shown in the drawing), the surfaces of which are formed with a series of space ridges to increase the overall surface area of the plate in contact with the absorbent liquid. The plates 28 are electrically heated, but could form part of a solar heated unit.

Another possible design of regenerator is to omit the heating elements form the container altogether, and heat the container by means of heating elements embedded in the base and/or walls of the container. A further possibility is to heat the absorbent liquid in the container by blowing hot air or steam through it. This has the additional advantage of facilitating nucleation of the carbon dioxide as it leaves the absorbent liquid. The exhaust gases from the fuel cell also may be used for the purpose: the exhaust gases are below regeneration temperature and therefore cannot be used to provide all the regeneration heat for the absorbent liquid, but when bubbled thorough the absorbent liquid they can assist nucleation.

The above-described apparatus is used as follows: the inlet A into the absorption reactor 2 is connected to a supply of pressurized air, and the outlet B is connected to an air storage tank (not shown) or direct to the fuel cell. The air need not be highly pressurized, since it simply needs enough pressure above atmospheric to push the air through the apparatus. Typically, 130-140 kpa is sufficient. The pressurized air may be supplied from any suitable means, e.g. a supply cylinder, a fan, a compressor or a blower. Preferably, the existing pump used to pump air into the fuel cell is able to handle the small additional load required to pressurise the air for this apparatus. Since the power for pressurising the air must come from the fuel cell, is essential that the presurization of the air is kept to the minimum necessary to force the air through the apparatus. It is therefore an advantage to keep the height of liquid above the air entry point to a minimum (i.e. to minimise the height of the section 2b ) whilst retaining sufficient volume of liquid to remove carbon dioxide from the air down to the required level.

As the compressed air enters the reactor 2 it is broken into separate dispersed airstreams by the spigots 21. The air rises to encounter the MEA/glycol mixture and the mixing units. The mixing units break up the air streams into bubbles, which pass up through the MEA/glycol solution. The relatively small bubble size (typically 5 mm diameter average) optimized the rate of absorption of carbon dioxide by the MEA.

The air moving up through the absorbent solution increases the effective volume of the solution into the overflow zone 2c of the reactor, and some of the solution rises above the regenerator inlet 4, so that solution starts to trickle down inlet 4 into the regenerator. Carbon dioxide—depleted air, with the carbon dioxide reduced below 20 ppm, collects at the top of the reactor 2 and leaves the reactor through the outlet B.

The provision of the overflow zone 2c means that the reactor can handle a relatively large volume of air: for example, a reactor of 200 mm diameter and 1200 mm long can cope with an inlet air flow rate of 100-1000 litres/minute.

The liquid tricking into the regenerator 3 moves under gravity down into the cylinder 8 surrounding the heater 6. It is an important feature of the present invention that the regenerator is gravity-fed rather than pumped, because a pumped regeneration system uses too much power to be practical for a remote site.

As the liquid trickles over the heater 6, the liquid is heated above 90° C. and the absorbed carbon dioxide is released and passes out of the regenerator as described above. For the heater to function effectively, i.e. so that most of the absorbent solution is regenerated, it is important that the contact between the solution and the heater is maximized, and that the solution passes through the heating zone relatively slowly.

The heat exchanger 10 is optional, but it is advantageous, because the absorbent solution must be cooled below 70° C. before it is returned to the reactor 2, since otherwise the MEA will not absorb carbon dioxide. It is not essential that all of the absorbent solution circulated through the regenerator is regenerated: providing the reactor 2 is dimensioned so that there is an effective over supply of MEA/glycol solution for the flow rate of air to be processed, the apparatus can function for a considerable period without regeneration, without any loss of effectiveness. This feature means that the heater in the regenerator may be operated only periodically if it is essential to conserve power. Alternatively, the regenerator may be designed for continual operation, but with a low regeneration rate.

It may be advantageous to incorporate a control for the apparatus. In this case, the amount of carbon dioxide absorbed by the absorbent solution is measured, e.g. by measuring the conductivity of the MEA/glycol solution as it leaves the reactor 2 or as it re-enters the reactor 2 from the regenerator and this reading is used to turn the heater off or on as required. The conductivity of the absorbent liquid varies with the amount of carbon dioxide which is has absorbed. Other features also vary with carbon dioxide absorption, e.g. pH, and any of these features may of course be used to govern the control system. Alternatively, the system can be set up for automatic operation if the air flow rate is constant.

It will be appreciated that the above described apparatus may be scaled up or scaled down as required.

1. Apparatus for removing carbon dioxide from a stream of air or other gas, said apparatus including: a substantially vertical gas absorption reactor which contains a plurality of loosely packed mixing units submerged in a carbon dioxide absorbent liquid; a gas inlet into the reactor, said inlet being arranged to admit in use an incoming stream of gas at or near the base of the reactor, and a gas outlet at or adjacent the top of the reactor through which the outgoing stream of treated gas leaves the reactor in use;
said reactor further being provided with a liquid outlet and a liquid inlet in the wall of the reactor, the liquid outlet being located higher up the wall of the reactor than the liquid inlet; a regenerator which incorporates heating means and which is provided with an inlet and the outlet and a carbon dioxide vent; the regenerator inlet being connected to the liquid outlet from the reactor, and the regenerator outlet being connected to the liquid inlet to the reactor.

2. Apparatus as claimed in claim 1, wherein said reactor is internally divided into four portions: a first portion adjacent the base of the reactor which provides a reservoir of absorbent liquid and which does not contain mixing units; a second portion extending from the top of said first portion to approximately the level of the liquid outlet, said second portion containing mixing units and in use being filled with the absorbent liquid; a third portion immediately above said second portion which contains mixing units and which provides an overflow zone in use; and a fourth portion at the top of the reactor in communication with the gas outlet.

3. The apparatus as claimed in claim 2 wherein said fourth portion contains means for removing droplets of absorbent liquid from gas leaving the reactor.

4. The apparatus as claimed in claim 3 wherein said means for removing droplets comprises one or more sheets of wire mesh.

5. The apparatus as claimed in any one of the preceding claims wherein the gas inlet terminates inside the reactor in a plurality of spaced spigots at or just below the junction between said first and second portions.

6. The apparatus as claimed in claim 1 wherein each mixing unit comprises an open-ended cylinder the walls which are pierced by multiple cutouts which are bent into the interior of the cylinder, forming multiple curved walls within the cylinder.

7. The apparatus as claimed in any one of the claims 1-4 wherein said regenerator comprises a container which incorporates heating means in the base and/or walls thereof.

8. The apparatus as claimed in any one of claims 1-4 wherein the heating means of said regenerator comprises an electrically heated plate arranged relative to the liquid outlet from the reactor such that in use liquid entering the regenerator from the reactor flows over the surface of said plate.

9. The apparatus as claimed in claim 8 wherein said plate is cylindrical.

10. The apparatus as claimed in claim 8 wherein said plate is a flat plate arranged substantially vertically in the regenerator.

11. The apparatus as claimed in claim 8 wherein said plate comprises one or more flat plates formed with surface projections, the or each said plate being arranged at an acute angle to the horizontal.

12. The apparatus as claimed in any one of claims 1-4 wherein said regenerator incorporates a heat exchanger.
